(19) United States
(12) Patent Application Publication
(10) Pub. No.: US 2013/0081271 A1
(43) Pub. Date: Apr. 4, 2013

(54) Method of Making Self-Ligating Orthodontic Brackets and Component Parts

(71) Applicant: F-CUBE, LTD., Loughborough (GB)

(72) Inventors: Farrokh Farzin-Nia, Inglewood, CA (US); Norbert Abels, Kirkel (DE); Claus Backes, Saarbruecken (DE)

(73) Assignee: F-CUBE, LTD., Loughborough (GB)

(21) Appl. No.: 13/645,180

(22) Filed: Oct. 4, 2012

Related U.S. Application Data
(60) Provisional application No. 61/542,916, filed on Oct. 4, 2011.

(51) Int. Cl. A61C 13/00

(52) U.S. Cl. CPC A61C 13/00
USPC 29/896.1

(57) ABSTRACT

A method of making a plurality of self-ligating orthodontic brackets or component parts thereof, in accordance with the principles of the invention, includes the steps of: (a) providing, in electronic form to or within an additive manufacturing system, a three-dimensional model of each of a plurality of self-ligating orthodontic brackets or component parts thereof; (b) forming a layer of particles, the particles having an average particle size of about 10 microns or less, the layer of particles having a depth of about 20 microns or less; (c) applying energy to a plurality of designated locations of the layer of particles in accordance with the three-dimensional model, thereby joining the particles together at each of the plurality of designated locations, the joined particles at each designated location being a layer of one of the plurality of self-ligating orthodontic brackets or component parts thereof or support structure; and (d) repeating steps (b) and (c) until the plurality of self-ligating orthodontic brackets or component parts thereof has been formed.

### CROSS-REFERENCE TO RELATED APPLICATION

This patent document claims the benefit of the filing date of Provisional Application No. 61/542,916, entitled “Method of Making Self-Ligating Orthodontic Brackets and Component Parts” and filed on Oct. 4, 2011. The entire disclosure of Provisional Application No. 61/542,916 is incorporated into this patent document by reference.

### FIELD OF THE INVENTION

This invention relates to orthodontic brackets, and in particular, to self-ligating orthodontic brackets.

### BACKGROUND OF THE INVENTION

Self-ligating orthodontic brackets are the latest generation of orthodontic brackets in the marketplace. These brackets have a ligation mechanism that allows an archwire to be contained within the bracket slot without the need for a separate ligation such as ligature wires or elastic bands. Addition of the ligation mechanism to the bracket design makes the bracket design significantly more complicated; and accordingly the bracket manufacturing process is appreciably more complicated.

Generally, self-ligating brackets are made by investment casting, particle injection molding, or machining. These methods have various limitations and drawbacks; and therefore, it is desirable to develop a new method of making such brackets—one that overcomes at least some of the limitations and drawbacks of the traditional manufacturing methods.

### SUMMARY OF THE INVENTION

In one aspect, a method of making a plurality of self-ligating orthodontic brackets or component parts thereof, in accordance with the principles of the invention, may include the steps of: (a) providing, in electronic form, to or within an additive manufacturing system, a three-dimensional model of each of a plurality of self-ligating orthodontic brackets and/or component parts thereof; (b) forming a layer of particles, the particles having an average particle size of about 10 microns or less, the layer of particles having a depth of about 20 microns or less; (c) applying energy to a plurality of designated locations of the layer of particles in accordance with the three-dimensional model, thereby joining the particles together at each of the plurality of designated locations, the joined particles at each designated location being a layer of one of the plurality of self-ligating orthodontic brackets and/or component parts thereof; and (d) repeating steps (b) and (c) until the plurality of self-ligating orthodontic brackets and/or component parts thereof has been formed.

In another aspect, a method of the invention may include the steps identified in the preceding paragraph, and may further include performing secondary processing of the self-ligating orthodontic brackets and/or component parts thereof.

### BRIEF DESCRIPTION OF THE DRAWINGS

The accompanying drawings, which are a part of this specification, illustrate embodiments of the invention. And together with the general description of the invention given above, and the detailed description of the drawings given below, the accompanying drawings explain the principles of the invention.

FIG. 1 is a flow chart of a method of making a plurality of self-ligating orthodontic brackets or component parts thereof, in accordance with the principles of the invention;

FIG. 2 is a perspective view of an exemplary self-ligating orthodontic bracket and supporting structure made in accordance with the principles of the invention;

FIG. 3 is another perspective view of the self-ligating orthodontic bracket and supporting structure of FIG. 2;

FIG. 4 is a top view of the self-ligating orthodontic bracket of FIG. 2, with the supporting structure having been removed;

FIG. 5 is a perspective view of a side of the self-ligating orthodontic bracket of FIG. 2, with the supporting structure having been removed; and

FIG. 6 is a highly schematic bottom view of another embodiment of a self-ligating orthodontic bracket made in accordance with the principles of the invention, illustrating the bonding surface of the bonding pad of the particular self-ligating orthodontic bracket.

### DETAILED DESCRIPTION OF THE INVENTION

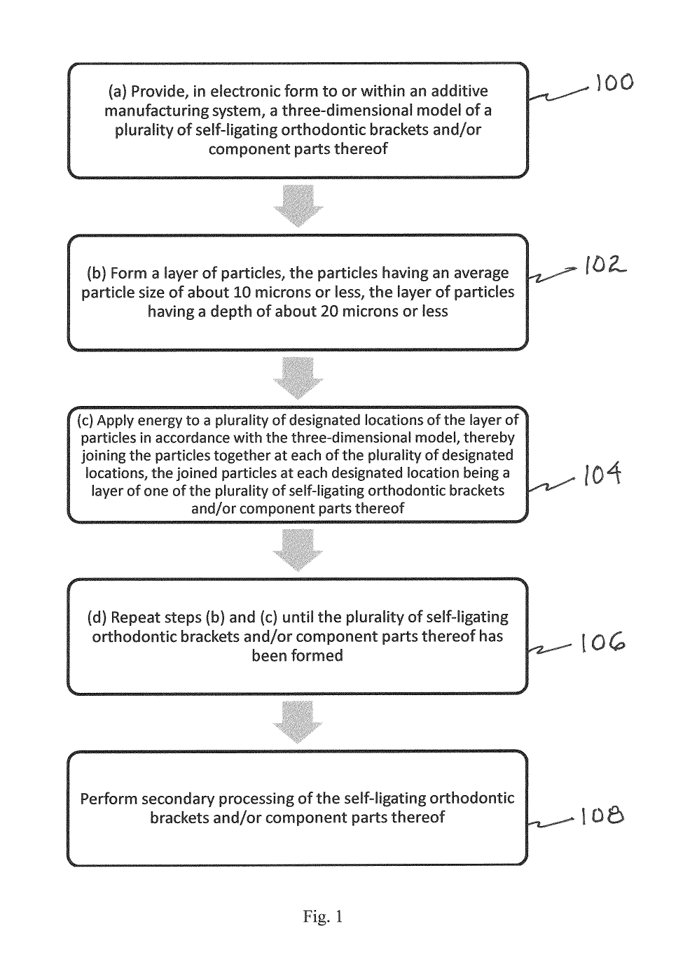

With reference to FIG. 1, a method of making a plurality of self-ligating orthodontic brackets and/or component parts thereof, in accordance with the principles of the invention, includes: (a) providing, in electronic form, to or within an additive manufacturing system, a three-dimensional model of each of a plurality of self-ligating orthodontic brackets and/or component parts thereof (100); (b) forming a layer of particles, the particles having an average particle size of about 10 microns or less, the layer of particles having a depth of about 20 microns or less (102); (c) applying energy to a plurality of designated locations of the layer of particles in accordance with the three-dimensional model, thereby joining the particles together at each of the plurality of designated locations, the joined particles at each designated location being a layer of one of the plurality of self-ligating orthodontic brackets and/or component parts thereof (104); and (d) repeating steps (b) and (c) until the plurality of self-ligating orthodontic brackets and/or component parts thereof has been formed (106). If desired, the method may further include performing secondary processing of the self-ligating orthodontic brackets and/or component parts thereof (108).

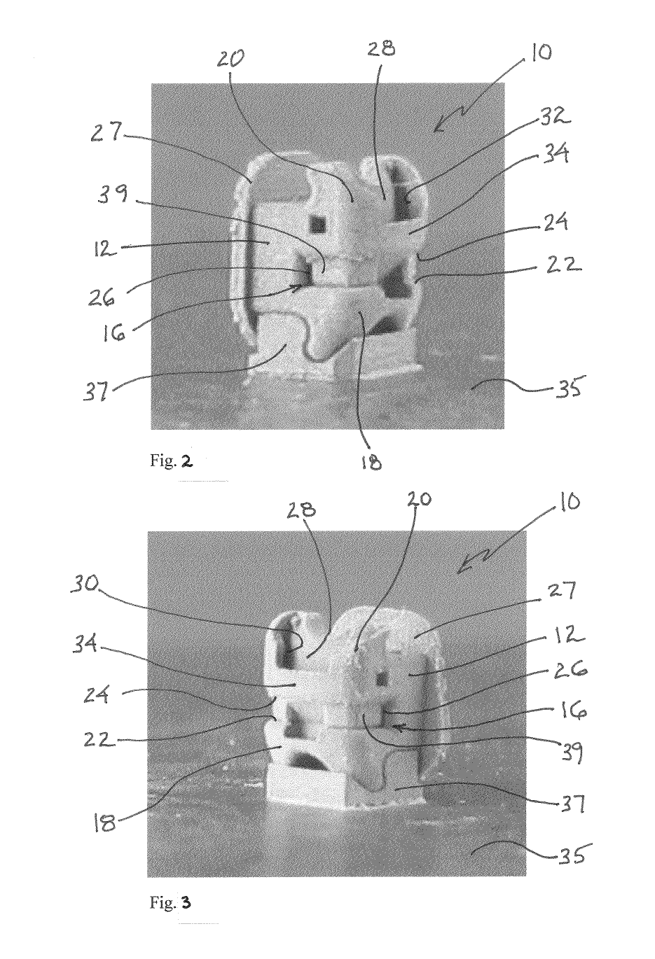

Exemplary self-ligating orthodontic brackets and component parts are described in detail below, in connection with FIGS. 2-6. The component parts may include, for example, a ligation mechanism, a bracket body, a bonding pad, and a ligation mechanism housing.

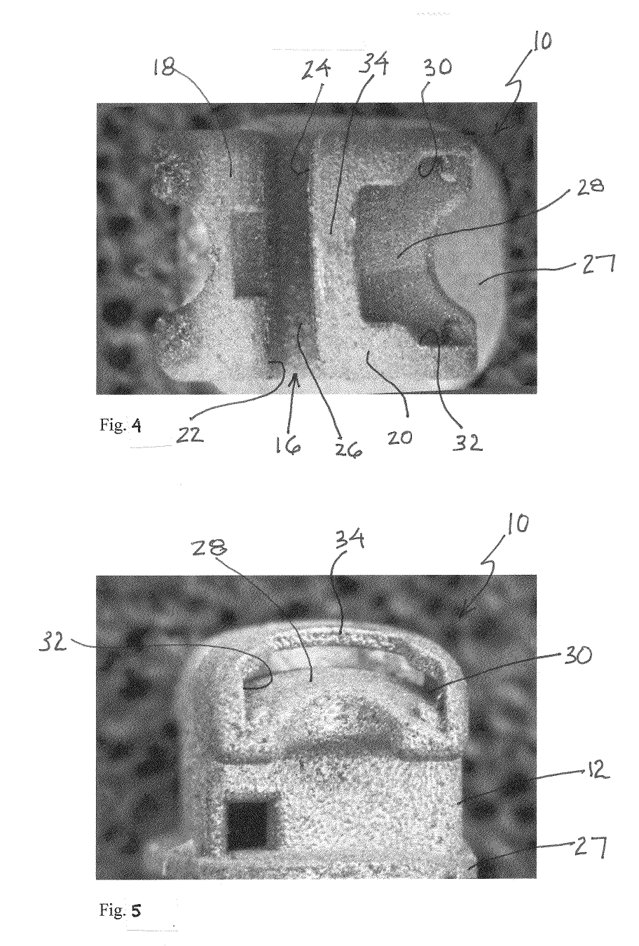

With reference to FIGS. 2-5, a particular self-ligating orthodontic bracket 10 made in accordance with the principles of the invention is shown. FIGS. 2 and 3 show the self-ligating orthodontic bracket and support structure after they have been made, but before secondary processing. FIGS. 4 and 5 show the self-ligating orthodontic bracket after the secondary processing step of removing the support structure. self-ligating orthodontic brackets and component parts often have complex shapes, including, for example, overhangs, undercuts and negative drafts. For self-ligating orthodontic brackets and parts with such shapes, it can be important to include one or more support structures. Advantageously, in the present invention, these may be incorporated into the three-dimensional (“3D”) designs, and printed as a part of the production process. Both the self-ligating orthodontic bracket and support structure are discussed in further detail below. The self-ligating orthodontic bracket shown in FIGS. 2-5 was made using a Laser additive manufacturing system made by eos of Guglingen, Germany.

The 3D design of the particular self-ligating orthodontic bracket shown in FIGS. 2-5 is substantially similar: to that of the self-ligating orthodontic bracket shown and described in detail in U.S. patent application Ser. No. 13/474,607, entitled “Self-Ligating Orthodontic Bracket with Flexible Ligating Slide” and filed on May 17, 2012; and to that of the self-ligating orthodontic bracket shown and described in detail in Provisional Application No. 61/488,735, entitled “Self-Ligating Orthodontic Bracket with Flexible Ligating Slide” and filed on May 21, 2011. The entire disclosure of each of U.S. patent application Ser. No. 13/474,607 and Provisional Application No. 61/488,735 is incorporated into this patent document by reference.

Referring to FIGS. 2-5, the self-ligating orthodontic bracket 10 includes a bracket body 12 for use with a ligation mechanism. An exemplary ligation mechanism in the form of a flexible ligating slide is shown in the '607 Application incorporated by reference above. (See the flexible ligating slide 14 in FIGS. 2-5 of the '607 Application.) The bracket body 12 includes an archwire slot 16, a first anterior portion 18 at a first side of the archwire slot 16, and a second anterior portion 20 at a second side of the archwire slot 16. The archwire slot 16 includes a first sidewall 22 at the first side, a second sidewall 24 at the second side, and a bottom wall 26 extending between the first and second sidewalls 22, 24. The bracket body 12 further includes an integral bonding pad or base 27.

The second anterior portion 20 includes a primary anterior surface 28, a first guide channel 30 and a second guide channel 32 extending anteriorly from the primary anterior surface 28, and a bridge member 34 spaced anteriorly from the primary anterior surface 28 and interconnecting the first and second guide channels 30, 32. Each of the first and second guide channels 30, 32 extends in a generally occlusal-gingival direction, with the channels 30, 32 being laterally spaced from one another in a generally mesial-distal direction. The bridge member 34 extends in a generally mesial-distal direction. The primary anterior surface 28, guide channels 30, 32, and bridge member 34 form an enclosed opening through which a flexible ligating slide (such as flexible ligating slide 14 in FIGS. 2-5 of the '607 Application) may be movably enclosed. The guide channels 30, 32 and bridge member 34 collectively comprise one example of what may be referred to as a ligation mechanism housing.

With reference to FIGS. 2 and 3, the 3D model of the self-ligating orthodontic bracket and support structure was electronically oriented so that the self-ligating orthodontic bracket 10 would be built in the orientation illustrated, with the planes of the first and second sidewalls 22, 24 of the archwire slot 16 substantially horizontal to the plane of the base plate 35 of the AM system—and substantially parallel with the plane of each layer of particles formed by the AM system. This orientation is particularly advantageous when making self-ligating orthodontic brackets such as the self-ligating orthodontic bracket 10 according to the inventive method.

As mentioned above, FIGS. 2 and 3 show both the self-ligating orthodontic bracket 10 and support structure (after they have been made, but before secondary processing). The support structure includes a support stand 37 that supports the self-ligating orthodontic bracket 10 on the base plate 35. The support structure also includes an archwire slot support member 39 positioned in the archwire slot 16. The first layer of the support stand 37 is removably attached to the base plate 35. This is accomplished as a part of the method, with the energy source applying energy to this designated area of the first layer of particles. The energy joins the particles together to form the first layer of the support stand 37; and the energy attaches the stand first layer to the base plate 35.

With reference to FIGS. 4 and 5, the self-ligating orthodontic bracket 10 is shown after the secondary processing step of removing the support stand 37 and the archwire slot support member 39. In this particular instance, the support stand 37 and slot support member 39 were separated or removed from the self-ligating orthodontic bracket 10 using wire electro-discharge manufacturing, also referred to as wire EDM. As illustrated, the self-ligating orthodontic bracket 10, has not been polished or otherwise finished.

The self-ligating orthodontic bracket 10 and support structure shown in FIGS. 2-5 were formed from stainless steel particles having an average particle size of about 3 microns, with 90% of the particles being smaller than 4 microns. After the additive manufacturing system applied energy to a designated area of a given layer of particles, the resulting layer of the self-ligating orthodontic bracket and/or support structure had a thickness or depth of 4-8 microns. The precision of the particular additive manufacturing system in the z-axis was 4-8 microns, the diameter of the laser beam was about 35 microns, and the resolution of the beam was 8 microns.

If desired, the method of making a plurality of self-ligating orthodontic brackets and/or component parts thereof, in accordance with the principles of the invention, may include using an additive manufacturing system to form a self-ligating orthodontic bracket in which the tooth-facing (e.g., bonding) surface of the self-ligating orthodontic bracket bonding pad includes grooves, protrusions, pockets, or the like, or combinations thereof. This may be accomplished, for example, by including 3D modeling for bonding-pad grooves, protrusions, and/or pockets in one or more of the 3D models of the particular self-ligating orthodontic bracket(s) and/or bonding-pad component parts being provided in electronic form to or within the additive manufacturing system. If desired, for such self-ligating orthodontic brackets, the bonding pad may be integrally formed with the bracket body during the additive manufacturing process. Such grooves, protrusions, and/or pockets can assist in forming a good adhesive bond between the self-ligating orthodontic bracket and the tooth enamel surface, such that the bracket remains adhered to the tooth under normal orthodontic forces. For metal self-ligating orthodontic brackets, the minimum forces can be 5 kg in tensile and 12 kg in shear.

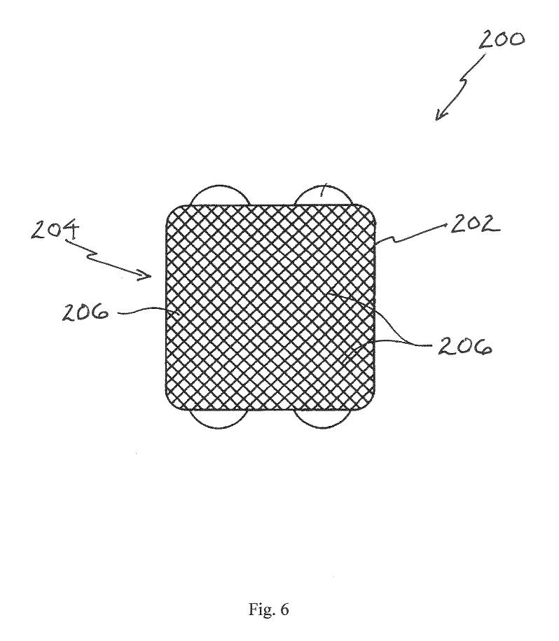

FIG. 6 is a highly schematic bottom view of another embodiment 200 of a self-ligating orthodontic bracket made in accordance with the principles of the invention, highlighting the tooth-facing surface 202 of the bracket bonding pad 204. The tooth-facing surface 202 includes grooves, protrusions, and/or pockets, as at 206.

If desired, one or more positioning jigs also may be formed as a part of the inventive additive manufacturing method. In use, a positioning jig may be used to assist in placing a self-ligating orthodontic bracket in a particular position on a patient's tooth. In the inventive additive manufacturing method, formation of one or more positioning jigs may be especially useful when the 3D model of a self-ligating orthodontic bracket or brackets is based on the dentition of a particular patient. For example, prior to making 3D models of various patient-specific self-ligating orthodontic brackets, the teeth of the particular patient may be electronically scanned or mapped. The information obtained from this scanning procedure then may be used to generate various patient-specific self-ligating orthodontic-bracket 3D models and corresponding 3D positioning-jig models. From these models, the additive manufacturing system then may be used to produce the brackets and corresponding jigs. Each jig that is produced is formed based on the evaluated optimum self-ligating orthodontic bracket position in relation to the particular tooth for which the self-ligating orthodontic bracket is being formed. In accordance with the invention, if desired, the additive manufacturing system may form the corresponding positioning jig(s) at the same time that the patient-specific self-ligating orthodontic bracket(s) are being formed. For example, the jigs and self-ligating orthodontic brackets may be formed in the same batch. In addition, if desired, a given self-ligating orthodontic bracket and corresponding jig may be formed such that they are connected. In this fashion, after positioning (using the jig) and bonding the self-ligating orthodontic bracket on the tooth for which it was made, the clinician may remove or separate (e.g., break off or cut off) the jig from the bracket.

Any suitable additive manufacturing system may be used. Typically, the additive manufacturing system includes one or more computers or computer components (e.g., processor(s), memory, storage, software, and the like), with at least one of the computers including a user interface (e.g., a keyboard and monitor, or the like). The additive manufacturing system typically further includes an additive manufacturing machine which itself may comprise one or more computer components. One example of a suitable additive manufacturing system is a Laser additive manufacturing system made by eos of Guglingen, Germany.

Typically, the additive manufacturing system also includes an energy source capable of joining particles of material together, a base plate (a.k.a. bottom plate) on which one or more self-ligating orthodontic brackets and/or related parts (e.g., component parts, supporting structure, positioning jigs, and/or the like) may be staged, and one or more elements for forming layers of particulate material. These components cooperate with one another, in accordance with specific electronic instructions, to build in a layer-by-layer fashion one or more self-ligating orthodontic brackets and/or related parts. Depending on the particular additive manufacturing system used, one or both of the energy source and the base plate may move relative to the other—typically in three dimensions (e.g., x-, y-, and z-axes or dimensions).

A 3D model of one or more self-ligating orthodontic brackets and/or related parts is electronically provided to or within the additive manufacturing system. Typically the 3D model is created using computer aided design (“CAD”) software. The 3D model may be electronically divided into many thin section models, with each section model representing a particular layer of the overall 3D model. Using these thin section models, the additive manufacturing system may produce the particular self-ligating orthodontic bracket and/or related part(s) specified by the 3D model, building the item(s) layer by layer.

The additive manufacturing system forms a very thin layer of fine particles on the base plate. Then the base plate and energy source cooperate to apply energy at one or more designated locations of that layer. Each designated location typically corresponds with: the thin section model for the particular layer of the overall 3D model; and how the 3D model(s) are oriented and arranged across a space that corresponds with the layout of the base plate. The energy joins the particles together at each designated location, thereby printing a layer of the particular self-ligating orthodontic bracket and/or related part(s).

The additive manufacturing system then deposits another very thin layer of particles on top of the existing layer; and the energy source applies energy at designated locations of that newly-deposited layer, in accordance with the design and layout instructions. The energy joins the newly-deposited particles together at the designated locations, and at the same time joins the particles of the new layer to the layer below. This process may continue until a specified number of 3D parts (e.g., particular self-ligating orthodontic brackets and/or related parts) is made.

If desired, the 3D models may be designed such that the ligation mechanism for a given self-ligating orthodontic bracket body is formed separate and apart from the self-ligating orthodontic bracket body. For example, the particular self-ligating orthodontic bracket body may be staged and built up at one location on the AM system base plate; and the corresponding ligation mechanism may be staged and built up at another location on the base plate. Alternatively, a 3D model (or combination of 3D models) may be designed such that the ligation mechanism for a given self-ligating orthodontic bracket body is formed with the self-ligating orthodontic bracket body. For example, the mechanism and bracket body may be staged and built up at the same location (e.g., generally the same x- and y-axis location) on the base plate. Also, if desired, the self-ligating orthodontic bracket body may be integrally formed with the bonding pad.

In forming a self-ligating orthodontic bracket or related part, if desired, a prefabricated part or component may be added during the additive manufacturing process. In this fashion, another desired related part may be formed at (e.g., directly adjacent) or near the prefabricated part. If formed directly adjacent the prefabricated part, the other related part may be formed such that it is integral with the prefabricated part.

The particles of a given layer (of a self-ligating orthodontic bracket or any related part) may comprise any suitable material or combination of materials. For example, the particles may be made of a stainless steel, titanium, a titanium alloy, a nickel/titanium (i.e., Ni/Ti) shape memory alloy, zirconium, a zirconium alloy, hafnium, a hafnium alloy, niobium, a niobium alloy, tantalum, a tantalum alloy, alumina, silicon carbide, silicon nitride, zirconia, and an engineering plastic.

In addition, one part or portion of a given part may be made of a material (or combination of materials) different from that of another part or portion of the given part. For example, for one particular self-ligating orthodontic bracket, a type-316 stainless-steel alloy may be used to make the self-ligating orthodontic bracket bonding pad; and a type-17-4 stainless steel may be used to make the self-ligating orthodontic bracket body. This may be the case regardless of whether the bonding pad and body are made as separate components or are integrally connected when formed.

Whether a self-ligating orthodontic bracket body and corresponding ligation mechanism are built up at the same staging location on the additive manufacturing system base plate or at different locations, the additive manufacturing system may, if desired, be instructed so that the bracket body has a material composition different from that of the ligation mechanism.

The particles may be joined in any of a number of different ways. For example, they may be joined by one or more of fusion, diffusion, dissolution, and curing. Any suitable energy source may be used. For example, the energy may be provided by one or more of an electromagnetic beam, a laser beam, an electron beam, an ultraviolet beam, and an ultrasonic wave.

If desired, the particles may have an average particle size of about 10 microns or less. A given layer of particles may have a depth of about 20 microns or less, preferably about 10 microns or less.

With regard to the additive manufacturing system, if desired, the z-axis movement of the energy source or the base plate may be about 40 microns or less. Also, if the energy source is in the form of a beam, the beam may have a diameter of about 80 microns or less.

If a number of self-ligating orthodontic brackets are going to be made in a single additive manufacturing batch or production run, the 3D models for the brackets (either identical or dissimilar brackets) may be electronically arranged so that the resulting brackets are aligned in one or more rows on the additive manufacturing system base plate. In arranging the 3D models for a given row, the models may be positioned so that, for the resulting brackets: the plane of one archwire slot sidewall of each bracket is coplanar with that of the other bracket(s); the plane of the other archwire slot sidewall of each bracket is coplanar with that of the other bracket(s); and the plane of the archwire slot bottom wall of each bracket is coplanar with that of at least some of the other bracket(s). This arrangement can be beneficial for secondary processing. For example, a single wire EDM cut may be made in several brackets simultaneously.

As noted above, self-ligating orthodontic brackets and related parts often have complex shapes, including, for example, overhangs, undercuts and negative drafts. For self-ligating orthodontic brackets and related parts with such shapes, it can be important to include one or more support structures. Advantageously, in the present invention, these may be incorporated into the 3D designs, and printed as a part of the production process. Such support structures may be separated or removed from the bracket or related part in a secondary processing step.

Support structure (one type of “related part”) may be made of any suitable material or combination of materials. Advantageously, the support structure comprises one or more materials that facilitate: minimal build time; minimal material(s) use (for example, a foam); minimal structure; and structure that may be removed easily in a secondary processing procedure (e.g., removed via ultrasonic energy, simple breakage, or the like). Typically, when multiple self-ligating orthodontic brackets are made on a single additive manufacturing system plate, it can be beneficial to build the self-ligating orthodontic brackets such that they are in alignment (e.g., coplanar archwire-slot sidewalls and coplanar archwire-slot bottom walls), as discussed above; however, when easily removable support-structure material(s) are used, such alignment may become less important, providing for greater flexibility in the electronic positioning of 3D models, and therefore, greater flexibility in the resulting location of self-ligating orthodontic brackets and related parts on the additive manufacturing system plate.

If desired, the surface roughness (Rₐ) of a self-ligating orthodontic bracket or related part made according to the invention may be in a range of from about 5 to about 100 microns.

After the self-ligating orthodontic brackets and/or component parts (and one or more support structures, as desired) have been formed, they may undergo secondary processing. Examples of secondary processing include: removing support structure; machining; densifying; sintering; applying hot isostatic pressing (also known as HIPping); heat treating; polishing; and surface finishing.

Following secondary processing, the self-ligating orthodontic brackets or parts preferably have a density greater than 90% of the theoretical density of the material, more preferably greater than 95%, and even more preferably greater than 97%.

If desired, within a given additive manufacturing production cycle (e.g., for a given batch), more than one particular 3D model may be formed as a part. For example, an operator may select a set of 3D models for a particular patient's entire dentition, whereby the additive manufacturing production run will result in the formation of a complete set of self-ligating orthodontic brackets for the particular patient. By way of further example, an operator may select the 3D model for each of a number of self-ligating orthodontic-bracket components (e.g., a ligation mechanism, a bracket body, a bonding pad, and a ligation mechanism housing), whereby the additive manufacturing production run will result in the formation of each of the specified self-ligating orthodontic-bracket component parts.

If desired, a number of self-ligating orthodontic brackets, component parts, and/or positioning-jig/self-ligating orthodontic-bracket pairings may be formed in a single additive manufacturing batch or production run. Depending on, for example, the sizes of the various brackets and parts, and the size of the base plate, several hundred brackets or parts may be made in one additive manufacturing batch. The 3D models may be arranged in any suitable fashion.

While the present invention has been illustrated by a description of embodiments, and while the illustrative embodiments have been described in considerable detail, it is not the intention of the inventor to restrict or in any way limit the scope of the following claims to such detail. Additional advantages and modifications readily will appear to those skilled in the art upon a reading of this patent document. The invention, in its broader aspects, is therefore not limited to the specific details, representative apparatus and methods, and illustrative examples shown and described in this patent document. Accordingly, departures may be made from such details without departing from the spirit or scope of the inventors' general inventive concept.

What is claimed is:

1. A method of making a plurality of self-ligating orthodontic brackets or component parts thereof, comprising the steps of:
(a) providing, in electronic form within an additive manufacturing system, a three-dimensional model of each of a plurality of self-ligating orthodontic brackets or component parts thereof;
(b) forming a layer of particles, the particles having an average particle size of about 10 microns or less, the layer of particles having a depth of about 20 microns or less;
(c) applying energy to a plurality of designated locations of the layer of particles in accordance with the three-dimensional model, thereby joining the particles together at each of the plurality of designated locations, the joined particles at each designated location being a layer of one of the plurality of self-ligating orthodontic brackets or component parts thereof or support structure; and
(d) repeating steps (b) and (c) until the plurality of self-ligating orthodontic brackets or component parts thereof has been formed.

2. The method of claim 1 wherein the energy is provided by one or more of an electromagnetic beam, a laser beam, an electron beam, an ultraviolet beam, and an ultrasonic wave.

3. The method of claim 1 wherein one or more of the layers comprises one or more of a stainless steel, titanium, a titanium alloy, a nickel/titanium shape memory alloy, zirconium, a zirconium alloy, hafnium, a hafnium alloy, niobium, a niobium alloy, tantalum, a tantalum alloy, alumina, silicon carbide, silicon nitride, zirconia, and an engineering plastic.

4. The method of claim 1 wherein the additive manufacturing system includes a base plate, and wherein the support structure is positioned between the base plate and one of the plurality of self-ligating orthodontic brackets or component parts thereof.

5. The method of claim 4 wherein the support structure is attached to the base plate and one of the plurality of self-ligating orthodontic brackets or component parts thereof.

6. The method of claim 1 further including performing secondary processing of the self-ligating orthodontic brackets or component parts thereof.

7. The method of claim 6 wherein the secondary processing includes one or more of removing support structure, machining, densifying, sintering, applying hot isostatic pressure, heat treating, polishing, and surface finishing.

8. The method of claim 7 wherein the support structure is removed using wire electro-discharge manufacturing.

9. The method of claim 1 wherein the plurality of self-ligating orthodontic brackets includes a bracket body having support structure positioned in an archwire slot.

10. The method of claim 9 wherein the support structure is removed using wire electro-discharge manufacturing.

11. The method of claim 1 wherein the plurality of self-ligating orthodontic brackets or component parts includes one or more of a bracket, a ligation mechanism, a bracket body, a bonding pad, and a ligation mechanism housing.

12. The method of claim 1 wherein the plurality of self-ligating orthodontic brackets or component parts includes at least one self-ligating orthodontic bracket, the self-ligating orthodontic bracket comprising a bracket body and a ligation mechanism.

13. The method of claim 12 wherein the material composition of the bracket body is different from the material composition of the ligation mechanism.

14. The method of claim 1 wherein the three-dimensional model is based on the dentition of a particular patient.

15. The method of claim 1 wherein the three-dimensional model is based on the aesthetic requirements of a particular patient.

16. The method of claim 1 wherein the three-dimensional model is based on the preferences of a particular clinician.

17. The method of claim 1 wherein the additive manufacturing system includes a base plate having a plane, and the providing step includes instructions for the arrangement of a plurality of self-ligating orthodontic brackets to be formed on the base plate, and wherein each of the plurality of self-ligating orthodontic brackets formed on the base plate has first and second archwire slot sidewalls, the first and second archwire slot sidewalls being substantially parallel with each other and the plane of the base plate.

18. The method of claim 1, wherein the additive manufacturing system includes a base plate, and the providing step includes instructions for forming a row of self-ligating orthodontic brackets on the base plate, each of the self-ligating orthodontic brackets of the row including a first archwire slot sidewall, a second archwire slot sidewall, and an archwire slot bottom wall, with the first archwire slot sidewalls being substantially coplanar, the second archwire slot sidewalls being substantially coplanar, and the archwire slot bottom walls being substantially coplanar or parallel with each other.

19. A plurality of self-ligating orthodontic brackets or component parts thereof made by the method of claim 1.

20. The method of claim 1 wherein the providing step includes a three-dimensional model of a self-ligating orthodontic bracket comprising an integral bonding pad that includes one or more of a plurality of grooves, protrusions, and pockets.

21. The method of claim 1 wherein the providing step includes a three-dimensional model of a positioning jig, and the repeating step results in the formation of the positioning jig.
